(19) United States
(12) Patent Application Publication
(10) Pub. No.: US 2007/0015412 A1
(43) Pub. Date: Jan. 18, 2007

(54) Cable of ultrasonic probe and ultrasonic probe

(75) Inventors: Hiroki Ito, Tokyo (JP); Mitsuhiro Nozaki, Tokyo (JP)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: GE Medical Systems Global Technology Company, LLC

(21) Appl. No.: 11/438,415

(22) Filed: May 22, 2006

(30) Foreign Application Priority Data
Jun. 9, 2005 (JP) 2005-169625

(51) Int. Cl. H01R 9/11

(52) U.S. Cl. 439/623

(57) ABSTRACT

With a view to providing a cable of an ultrasonic probe, as well as an ultrasonic probe using the cable, which can improve the operability in ultrasonic diagnosis without impairing the reliability of the ultrasonic probe, the thickness of a sheath portion (a length position thereof) which constitutes a cable at a position near a mounted position of an ultrasonic probe head is selected so as to be larger than the thickness of the sheath portion (a length position thereof) which constitutes the cable at a position spaced away from the mounted position of the ultrasonic probe head.

### BACKGROUND OF THE INVENTION

The present invention relates to a cable of an ultrasonic probe and more particularly to a cable of an ultrasonic probe which cable is not uniform at arbitrary positions, as well as an ultrasonic probe using the cable.

Heretofore there has been known an ultrasonic image system wherein an ultrasonic wave is radiated to a subject (human body) and a reflected wave (echo) from the subject is imaged to pick up an image of the interior of the subject. Since ultrasonic wave is harmless to the human body, this ultrasonic image system is useful for medical use and is used for example in the detection of a foreign matter present within a living body, determination of the degree of a trauma, observation of a tumor and of a fetus.

For example in ultrasonic diagnosis using such an ultrasonic image system there is performed ultrasonic inspection using an ultrasonic probe. FIG. 9 shows an entire configuration of an ultrasonic diagnostic apparatus 1 provided with an ultrasonic probe. As shown in the same figure, the ultrasonic diagnostic apparatus 1 is provided with a body 2, a monitor 3 and an ultrasonic probe 10. The ultrasonic probe 10 comprises an ultrasonic probe head 20 which transmits or receives an ultrasonic wave and a cable 30 which is connected to the body 2 of the ultrasonic diagnostic apparatus 1.

Ultrasonic inspection using the ultrasonic probe 10 is performed by bringing the ultrasonic probe head 20 against a site (e.g., abdomen) of a human body, then radiating an ultrasonic wave to the site to be inspected, thereby acquiring a tomographic image of the site to be inspected, and displaying the acquired tomographic image on the monitor 3.

As this type of a conventional technique related to a cable of an ultrasonic probe, as well as an ultrasonic probe using the cable, there is described for example in Patent Literature 1 a technique wherein a coaxial cable connected to an ultrasonic oscillator and a coil is disposed within a slot formed in a substrate of a probe head, thereby permitting the coaxial cable to be moved freely during operation of the ultrasonic probe.

[Patent Literature 1] Japanese Patent Laid Open No. 2003-061962

However, the above cable of the ultrasonic probe and the ultrasonic probe using the cable involve the following problem. That is, in ultrasonic diagnosis using the above ultrasonic probe, a certain degree of operability is required and therefore, for example with a view to improving the operability in inspection using the ultrasonic probe, the thickness (diameter) of the probe cable itself which constitutes the ultrasonic probe is made small or a soft material is used as the material of a sheath portion which constitutes the ultrasonic probe, to afford a flexible structure as a whole, whereby it is possible to enhance the flexibility of the cable.

On the other hand, if the structure of the probe cable is made flexible as a whole, there is a fear that there may occur an undesirable phenomenon such as breaking of interior signal lines which constitute the probe cable in the vicinity of a mounted portion of the probe head. As a result, a problem is likely to occur such as impairment of the inspection reliability. For this reason, it is desired to provide a cable of an ultrasonic probe, as well as an ultrasonic probe using the cable, which permit the probe cable to have a certain degree of rigidity in the vicinity of the mounted position of the probe head as in the prior art and which permit the probe cable to be flexible in the other portion.

### SUMMARY OF THE INVENTION

It is therefore an object of the invention to provide a cable of an ultrasonic probe, as well as an ultrasonic probe using the cable, which not only can improve the operability in ultrasonic inspection using an ultrasonic probe but also can maintain the inspection reliability to a satisfactory extent.

For solving the above-mentioned problem and for achieving the above-mentioned object, in a first aspect of the present invention, there is provided a cable of an ultrasonic probe for connection between an ultrasonic probe head to be brought into abutment against a site to be inspected of a subject and a body of an ultrasonic diagnostic apparatus, characterized in that the thickness of a sheath portion which constitutes the cable on the side connected to the ultrasonic probe head is selected so as to be larger than the thickness of a sheath portion which constitutes the cable on the side connected to the body of the ultrasonic diagnostic apparatus.

According to the first aspect of the present invention, the thickness of a sheath portion which constitutes the cable on the side connected to the ultrasonic probe head is selected so as to be larger than the thickness of a sheath portion which constitutes the cable on the side connected to the body of the ultrasonic diagnostic apparatus.

In a second aspect of the present invention, the thickness of the sheath portion which constitutes the cable on the side connected to the ultrasonic probe head is selected so as to become larger stepwise or continuously as the side connected to the ultrasonic probe head is approached.

According to the second aspect of the present invention, the thickness of the sheath portion which constitutes the cable on the side connected to the ultrasonic probe head is selected so as to become larger stepwise or continuously as the side connected to the ultrasonic probe head is approached.

In a third aspect of the present invention there is provided a cable of an ultrasonic probe for connection between an ultrasonic probe head to be brought into abutment against a site to be inspected of a subject and a body of an ultrasonic diagnostic apparatus, characterized in that the hardness of a sheath portion which constitutes the cable on the side connected to the ultrasonic probe head is selected so as to be larger than the hardness of a sheath portion which constitutes the cable on the side connected to the body of the ultrasonic diagnostic apparatus.

According to the third aspect of the present invention, the hardness of a sheath portion which constitutes the cable on the side connected to the ultrasonic probe head is selected so as to be larger than the hardness of a sheath portion which constitutes the cable on the side connected to the body of the ultrasonic diagnostic apparatus.

In a fourth aspect of the present invention, the hardness of the sheath portion which constitutes the cable on the side connected to the ultrasonic probe head is selected so as to become larger stepwise or continuously as the side connected to the ultrasonic probe head is approached.

According to the fourth aspect of the present invention, the hardness of the sheath portion which constitutes the cable on the side connected to the ultrasonic probe head is selected so as to become larger stepwise or continuously as the side connected to the ultrasonic probe head is approached.

In a fifth aspect of the present invention there is provided a cable of an ultrasonic probe for connection between an ultrasonic probe head to be brought into abutment against a site to be inspected of a subject and a body of an ultrasonic diagnostic apparatus, characterized in that the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the diameter of the shielding tubular member on the side connected to the ultrasonic probe head is selected so as to be larger than the diameter of the shielding tubular member on the side connected to the body of the ultrasonic diagnostic apparatus.

According to the fifth aspect of the present invention, the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the diameter of the shielding tubular member on the side connected to the ultrasonic probe head is selected so as to be larger than the diameter of the shielding tubular member on the side connected to the body of the ultrasonic diagnostic apparatus.

In a sixth aspect of the present invention, the diameter of the shielding tubular member on the side connected to the ultrasonic probe head is selected so as to become larger stepwise or continuously than the diameter of the shielding tubular member on the side connected to the body of the ultrasonic diagnostic apparatus.

According to the sixth aspect of the present invention, the diameter of the shielding tubular member near a mounted position of the ultrasonic probe head is selected so as become larger stepwise or continuously than the diameter of the shielding tubular member on the side connected to the body of the ultrasonic diagnostic apparatus.

In a seventh aspect of the present invention there is provided a cable of an ultrasonic probe for connection between an ultrasonic probe head to be brought into abutment against a site to be inspected of a subject and a body of an ultrasonic diagnostic apparatus, characterized in that the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the knitting density of the plural linear members is selected so that the knitting size becomes smaller as the side connected to the probe head is approached.

According to the seventh aspect of the present invention, the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the knitting density of the plural linear members is selected so that the knitting size becomes smaller as the side connected to the probe head is approached.

In an eighth aspect of the present invention, the knitting density of the plural linear members is selected so that the knitting size becomes smaller stepwise or continuously as the side connected to the ultrasonic probe head is approached.

According to the eighth aspect of the present invention, the knitting density of the plural linear members is selected so that the knitting size becomes smaller stepwise or continuously as the side connected to the ultrasonic probe head is approached.

In a ninth aspect of the present invention there is provided a cable of an ultrasonic probe for connection between an ultrasonic probe head to be brought into abutment against a site to be inspected of a subject and a body of an ultrasonic diagnostic apparatus, characterized in that the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the diameter of each of the linear members which constitute the shielding tubular member on the side connected to the ultrasonic probe head is selected so as to be larger than the diameter of each of the linear members which constitute the shielding tubular member on the side connected to the body of the ultrasonic diagnostic apparatus.

According to the ninth aspect of the present invention, the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the diameter of each of the linear members which constitute the shielding tubular member on the side connected to the ultrasonic probe head is selected so as to be larger than the diameter of each of the linear members which constitute the shielding tubular member on the side connected to the body of the ultrasonic diagnostic apparatus.

In a tenth aspect of the present invention, the diameter of each of the linear members which constitute the shielding tubular member on the side connected to the ultrasonic probe head is selected so as to become larger stepwise or continuously than the diameter of each of the linear members which constitute the shielding tubular member on the side connected to the body of the ultrasonic diagnostic apparatus.

According to the tenth aspect of the present invention, the diameter of each of the linear members which constitute the shielding tubular member on the side connected to the ultrasonic probe head becomes larger stepwise or continuously than the diameter of each of the linear members which constitute the shielding tubular member on the side connected to the body of the ultrasonic diagnostic apparatus.

In an eleventh aspect of the present invention, the thickness of the sheath portion which constitutes the cable on the side connected to the ultrasonic probe head is selected so as to be larger than the thickness of the sheath portion which constitutes the cable on the side connected to the body of the ultrasonic diagnostic apparatus.

According to the eleventh aspect of the present invention, the thickness of the sheath portion which constitutes the cable on the side connected to the ultrasonic probe head is selected so as to be larger than the thickness of the sheath portion which constitutes the cable on the side connected to the ultrasonic probe head.

In a twelfth aspect of the present invention, the hardness of the sheath portion which constitutes the cable on the side connected to the ultrasonic probe head is selected so as to be larger than the hardness of the sheath portion which constitutes the cable on the side connected to the body of the ultrasonic diagnostic apparatus.

According to the twelfth aspect of the present invention, the hardness of the sheath portion which constitutes the cable on the side connected to the ultrasonic probe head is selected so as to be larger than the hardness of the sheath portion which constitutes the cable on the side connected to the body of the ultrasonic diagnostic apparatus.

In a thirteenth aspect of the present invention, the rigidity of the sheath portion which constitutes the cable on the side connected to the ultrasonic probe head is selected so as to be larger than the rigidity of the sheath portion which constitutes the cable on the side connected to the body of the ultrasonic diagnostic apparatus.

According to the thirteenth aspect of the present invention, the rigidity of the sheath portion which constitutes the cable on the side connected to the ultrasonic probe head is selected so as to be larger than the rigidity of the sheath portion which constitutes the cable on the side connected to the body of the ultrasonic diagnostic apparatus.

In a fourteenth aspect of the present invention there is provided an ultrasonic probe comprising a cable for connection between an ultrasonic probe head to be brought into abutment against a site to be inspected of a subject and a body of an ultrasonic diagnostic apparatus, characterized in that the thickness of a sheath portion which constitutes the cable on the side connected to the ultrasonic probe head is selected so as to be larger than the thickness of a sheath portion which constitutes the cable on the side connected to the body of the ultrasonic diagnostic apparatus.

According to the fourteenth aspect of the present invention, the thickness of a sheath portion which constitutes the cable on the side connected to the ultrasonic probe head is selected so as to be larger than the thickness of a sheath portion which constitutes the cable on the side connected to the body of the ultrasonic diagnostic apparatus.

In a fifteenth aspect of the present invention there is provided an ultrasonic probe comprising a cable for connection between an ultrasonic probe head to be brought into abutment against a site to be inspected of a subject and a body of an ultrasonic diagnostic apparatus, characterized in that the hardness of a sheath portion which constitutes the cable on the side connected to the ultrasonic probe head is selected so as to be larger than the hardness of a sheath portion which constitutes the cable on the side connected to the body of the ultrasonic diagnostic apparatus.

According to the fifteenth aspect of the present invention, the hardness of a sheath portion which constitutes the cable on the side connected to the ultrasonic probe head is selected so as to be larger than the hardness of a sheath portion which constitutes the cable on the side connected to the body of the ultrasonic diagnostic apparatus.

In a sixteenth aspect of the present invention there is provided an ultrasonic probe comprising a cable for connection between an ultrasonic probe head to be brought into abutment against a site to be inspected of a subject and a body of an ultrasonic diagnostic apparatus, characterized in that the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the diameter of the shielding tubular member on the side connected to the ultrasonic probe head is selected so as to be larger than the diameter of the shielding tubular member on the side connected to the body of the ultrasonic diagnostic apparatus.

According to the sixteenth aspect of the present invention, the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the diameter of the shielding tubular member on the side connected to the ultrasonic probe head is selected so as to be larger than the diameter of the shielding tubular member on the side connected to the body of the ultrasonic diagnostic apparatus.

In a seventeenth aspect of the present invention there is provided an ultrasonic probe comprising a cable for connection between an ultrasonic probe head to be brought into abutment against a site to be inspected of a subject and a body of an ultrasonic diagnostic apparatus, characterized in that the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the knitting density of the plural linear members is selected so that the knitting size becomes smaller as the side connected to the ultrasonic probe head is approached.

According to the seventeenth aspect of the present invention, the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, the shielding tubular member being constituted by a plurality of linear members knitted like a net, and the knitting density of the plural linear members is selected so that the knitting size becomes smaller as the side connected to the ultrasonic probe head is approached.

According to the present invention, since the thickness of the sheath portion which constitutes the cable on the side connected to the ultrasonic probe head as a constituent of the ultrasonic probe is selected so as to be larger than the thickness of the sheath portion which constitutes the cable on the side connected to the body of the ultrasonic diagnostic apparatus, the probe cable portion which is subjected to repeated bending during ultrasonic inspection can retain a certain degree of strength as in the prior art, while the other portion can be made flexible. As a result, there is obtained an effect such that the operability in ultrasonic inspection can be improved while maintaining the structural reliability.

According to the present invention, since the hardness of the sheath portion which constitutes the cable on the side connected to the ultrasonic probe head is selected so as to be larger than the hardness of the sheath portion which constitutes the cable on the side connected to the body of the ultrasonic diagnostic apparatus, the probe cable portion which is subjected to repeated bending during ultrasonic inspection can retain a certain degree of strength as in the prior art, while the other portion can be made flexible. As a result, there is obtained an effect such that the operability in ultrasonic inspection can be improved while maintaining the structural reliability.

According to the present invention, since the shielding tubular member which constitutes the cable of the ultrasonic probe is constituted by a plurality of linear members knitted like a net and the diameter of the shielding tubular member on the side connected to the ultrasonic probe head is selected so as to be larger than the diameter of the shielding tubular member on the side connected to the body of the ultrasonic diagnostic apparatus, the cable portion of the ultrasonic probe which is subjected to repeated bending during ultrasonic inspection can retain a certain degree of strength as in the prior art, while the other portion can be made flexible. As a result, there is obtained an effect such that the operability in ultrasonic inspection can be improved while maintaining the structural reliability.

Moreover, according to the present invention, since the shielding tubular member which constitutes the cable of the ultrasonic probe is constituted by a plurality of linear members knitted like a net and the knitting density of the plural linear members is selected so that the knitting size becomes smaller as the mounted position of the ultrasonic probe head is approached, the cable portion of the ultrasonic probe which is subjected to repeated bending during ultrasonic inspection can retain a certain degree of strength as in the prior art, while the other portion can be made flexible. As a result, there is obtained an effect such that the operability in ultrasonic inspection can be improved while maintaining the structural reliability.

Further, according to the present invention, since the shielding tubular member which constitutes the cable of the ultrasonic probe is constituted by a plurality of linear members knitted like a net and the knitting density is selected so that the knitting size becomes smaller stepwise or continuously as the side connected to the ultrasonic probe head is approached, the cable portion of the ultrasonic probe which is subjected to repeated bending during ultrasonic inspection can retain a certain degree of strength as in the prior art, while the other portion can be made flexible. As a result, there is obtained an effect such that the operability in ultrasonic inspection can be improved while maintaining the structural reliability.

Thus, the cable of the ultrasonic probe, as well as the ultrasonic probe, according to the present invention are suitable for application to the purpose of improving the operability in ultrasonic inspection using an ultrasonic probe in an ultrasonic diagnostic apparatus.

Further objects and advantages of the present invention will be apparent from the following description of the preferred embodiments of the invention as illustrated in the accompanying drawings.

### BRIEF DESCRIPTION OF THE DRAWINGS

FIG. 1 is a partial sectional view of a principal portion, showing the configuration of an ultrasonic cable according to a first embodiment of the present invention;

FIG. 2 is a vertical sectional view showing an internal configuration of the probe cable illustrated in FIG. 1:

FIG. 3 is a horizontal sectional view showing an internal configuration of a sheath portion illustrated in FIG. 1;

FIG. 4 is a horizontal sectional view showing an internal configuration of a sheath portion according to a second embodiment of the present invention;

FIG. 5 is a horizontal sectional view showing an internal configuration of a sheath portion according to a third embodiment of the present invention;

FIG. 6 is a horizontal sectional view showing an internal configuration of a sheath portion and that of a shielding tubular member according to a fourth embodiment of the present invention;

FIG. 7 is an enlarged view showing an internal configuration of a shielding tubular member according to a fifth embodiment of the present invention;

FIG. 8 is an enlarged view showing an internal configuration of a shielding tubular member according to a sixth embodiment of the present invention; and

FIG. 9 is an entire configuration diagram showing an outline of an ultrasonic diagnostic apparatus provided with an ultrasonic probe.

### DETAILED DESCRIPTION OF THE INVENTION

The cable of the ultrasonic probe, as well as the ultrasonic probe, according to the present invention will be described in detail hereinunder by way of preferred embodiments thereof with reference to the accompanying drawings. In the following first to sixth embodiments an outline and features of the cable of the ultrasonic probe, as well as the ultrasonic probe, will be described and subsequently the constructions and functions thereof will be described.

### First Embodiment

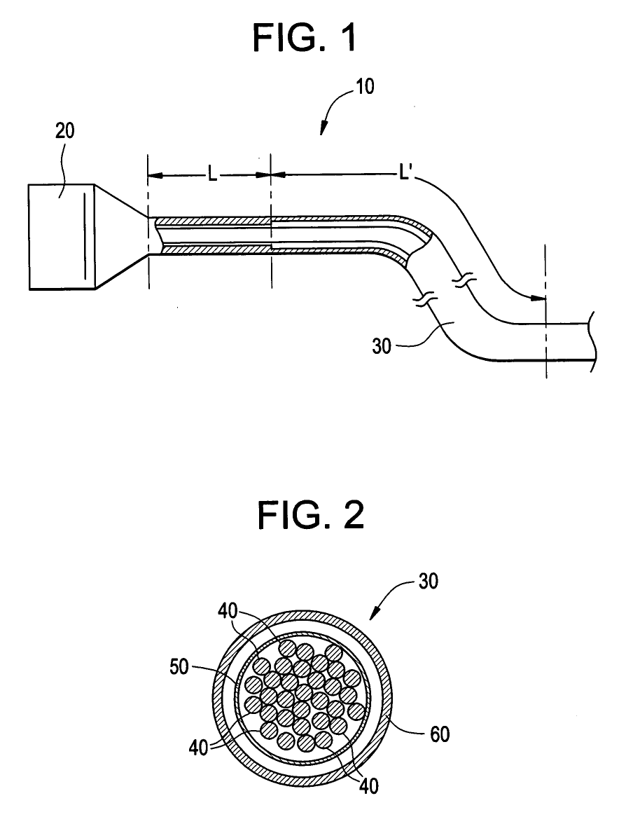

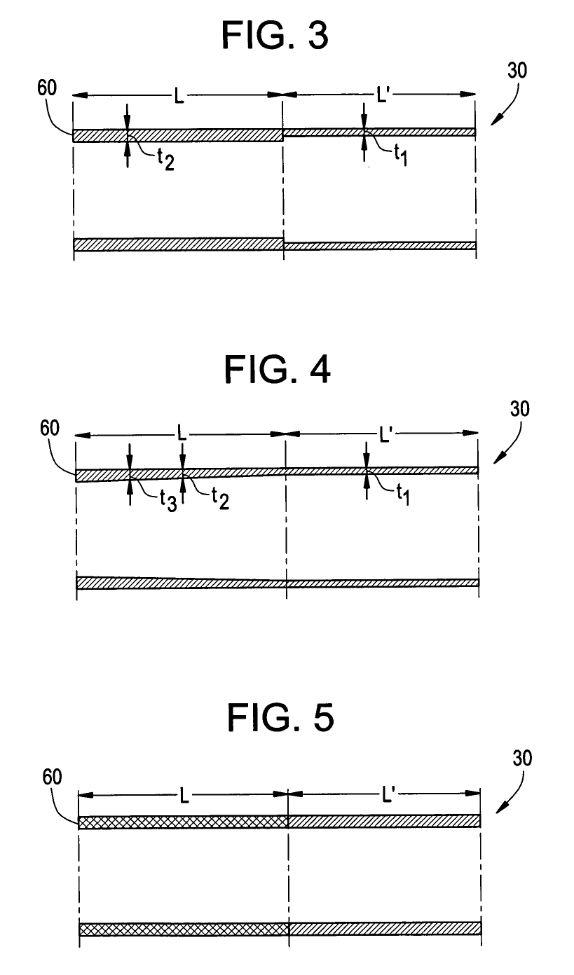

FIG. 1 is an entire configuration diagram of an ultrasonic probe 10 which is applied to the ultrasonic probe cable and the ultrasonic probe according to the present invention, FIG. 2 is a vertical sectional view of a cable 30 which constitutes the ultrasonic probe 10, and FIG. 3 is a horizontal sectional view of a sheath portion 60 which constitutes the cable 30. In FIGS. 1 and 3, out of FIGS. 1 to 3, other members (e.g., a shielding tubular member 50 and signal lines 40) than the shield portion 60 which constitutes the cable 30 are omitted for clarifying characteristic portions of this first embodiment.

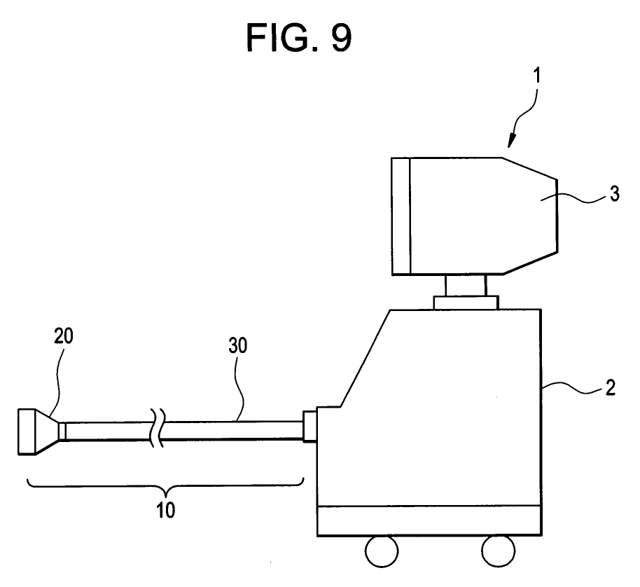

As shown in FIG. 1, the ultrasonic probe 10 is made up of an ultrasonic probe head 20 for transmitting or receiving an ultrasonic wave and the cable 30. The cable 30 is connected to a body 2 of an ultrasonic diagnostic apparatus 1 (FIG. 9). The ultrasonic probe head 20 radiates an ultrasonic wave to a subject and is provided in the interior thereof with an ultrasonic element (not shown) for receiving a reflected wave from the subject, an acoustic lens (not shown) for converging the received ultrasonic wave and a piezoelectric element (not shown). With the piezoelectric element provided within the ultrasonic probe head 20, the received reflected wave is converted to an electric signal, which signal is then transmitted through the cable 30 to the ultrasonic diagnostic apparatus (FIG. 9).

As shown in FIG. 2, the cable 30 comprises a plurality of signal lines 40 for transmitting electric signals to the probe head 10, a shielding tubular member 50 which encloses the plural signal lines 40, and a sheath portion 60 which encloses the shielding tubular member 50. A flexible material is selected as the material of the sheath portion 60. The shielding tubular member 50 is constituted by a plurality of fine linear members 51 (FIG. 7) knitted like a net.

This first embodiment is characteristic in that the thickness of the sheath portion 60 which constitutes the cable 30 on the side connected to the probe head 20 is selected so as to be larger than the thickness of the sheath portion 60 which constitutes the cable 30 on the side connected to the body of the ultrasonic diagnostic apparatus.

The construction of the cable 30 used in this first embodiment will be described below in detail with reference to FIGS. 1 to 3. As noted previously, the sheath portion 60 (a length position L of the sheath portion 60) which constitutes the cable 30 at a position near the mounted position of the probe head 20 cannot be made flexible because this portion is subjected to a relatively frequent repetition of bending in ultrasonic inspection, but the other portion (a length position L′ of the sheath portion 60) can be made relatively flexible.

In this first embodiment, taking note of the point just mentioned above, the thickness of the sheath portion 60 (the length position L thereof) which constitutes the cable 30 at a position near the mounted position of the probe head 20 is selected so as to be larger than the thickness of the sheath portion 60 (the length position L′ thereof) which constitutes the cable 30 at a position spaced away from the mounted position of the probe head 20.

On the other hand, the thickness of the sheath portion 60 (the length position L′ thereof) which constitutes the cable 30 at a position spaced away from the mounted position of the probe head 20 is selected so as to be smaller than the thickness of the sheath portion 60 (the length position L thereof) which constitutes the cable 30 at a position near the mounted position of the probe head 20.

More specifically, in the cable 30, as shown in FIG. 3, given that the thickness of the sheath portion 60 at the length position L is t₂ and the thickness of the sheath portion 60 at the length position L′ is t₁, the thicknesses t₁ and t₂ are selected so as to satisfy the relationship of t₂>t₁.

According to this first embodiment, as described above, the cable 30 portion which is subjected to repeated bending in ultrasonic inspection, (the sheath portion 60 which constitutes the cable 30 at a position near the mounted position of the probe head 20), can retain a certain degree of strength as in the prior art and the other portion (the sheath portion 60 which constitutes the cable 30 at a position spaced away from the mounted position of the probe head 20), by being made flexible, can be improved in its operability in ultrasonic inspection while maintaining its structural reliability.

### Second Embodiment

Next, a second embodiment of the cable of the ultrasonic probe, as well as the ultrasonic probe, according to the present invention will be described below with reference to FIG. 4. FIG. 4, like FIG. 3, is a horizontal sectional view of a sheath portion 60 which constitutes a cable 30.

As shown in FIG. 4, this second embodiment is characteristic in that the thickness of the sheath portion 60 is selected so as to become larger stepwise or continuously as the mounted position of the ultrasonic probe head 20 is approached.

More specifically, given that the length of the sheath portion 60 positioned near the mounted position of the ultrasonic probe head 20 is L, an arbitrary length of the sheath portion 60 spaced away from the mounted position of the ultrasonic probe head 20 is L′, thicknesses of the sheath portion 60 at the length position L are t₃ and t₂, and the thickness of the sheath portion 30 at the length position L′ is t₁, those thicknesses are selected so as to satisfy the relationship of t₃>t₂>t₁.

As described above, according to this second embodiment, like the previous first embodiment, the portion of the cable 30 which is subjected to frequent bending in ultrasonic inspection, (the length position L near the ultrasonic probe head 20), can retain a certain degree of strength as in the prior art and the other portion, by being made flexible, can be improved in its operability in ultrasonic inspection while retaining its reliability.

Further, in this second embodiment, since the thickness of the sheath portion 60 is selected so as to gradually become larger stepwise or continuously as the mounted position of the ultrasonic probe head 20 is approached, a flexible operability can be expected in the entire cable 30 without a change in flexibility at an arbitrary branch position as a structural change position.

### Third Embodiment

A third embodiment of the cable of the ultrasonic probe, as well as the ultrasonic probe, according to the present invention will be described below with reference to FIG. 5. FIG. 5, like FIGS. 3 and 4, is a horizontal sectional view of a sheath portion 60 which constitutes a cable 30.

As shown in FIG. 5, this third embodiment is characteristic in that the hardness (rigidity) of the sheath portion 60 which constitutes the cable 30 at a position near the mounted position of the ultrasonic probe head 20 is selected so as to be larger than the hardness (rigidity) of the sheath portion 60 which constitutes the cable 30 at a position spaced away from the mounted position of the ultrasonic probe head 20.

More specifically, as shown in FIG. 5, the hardness (rigidity) of a resin material used as the material of the sheath portion 60 (the length L position thereof) which constitutes the cable 30 at a position near the mounted position of the ultrasonic probe head 20 is selected so as to be larger than the hardness (rigidity) of a resin material of the sheath portion 60 (the length L′ position thereof) which constitutes the cable 30 at a position spaced away from the mounted position of the ultrasonic probe head 20. In other words, the hardness (rigidity) of the resin material used at the length position L′ of the sheath portion 60 is selected so as to be smaller than the hardness (rigidity) of the resin material used at the length position L of the sheath portion 60.

According to this third embodiment, as described above, since the hardness (rigidity) of the sheath portion 60 which constitutes the cable 30 at a position near the mounted position of the ultrasonic probe head 20 is selected so as to be larger than the hardness (rigidity) of the sheath portion 60 which constitutes the cable 30 at a position spaced away from the mounted position of the ultrasonic probe head 20, the portion of the cable 30 which is subjected to repeated bending in ultrasonic inspection, (the sheath portion 60 which constitutes the cable 30 at a position near the mounted position of the ultrasonic probe head 20), can retain a certain degree of strength as in the prior art and the other portion (the sheath portion 60 which constitutes the cable 30 spaced away from the mounted position of the ultrasonic probe head 20), by being made to have a flexible structure of a reduced hardness, can be improved in its operability in ultrasonic inspection while retaining it structural reliability.

### Fourth Embodiment

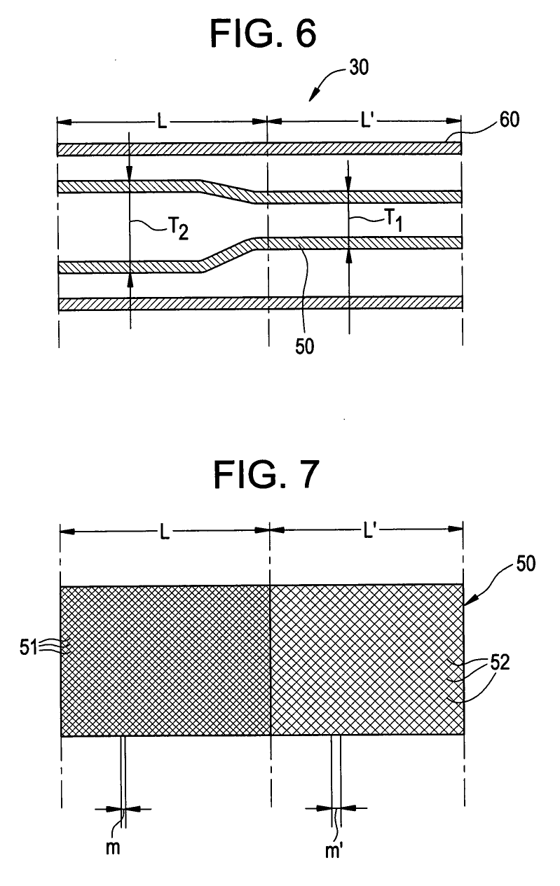

Next, a fourth embodiment of the cable of the ultrasonic probe, as well as the ultrasonic probe, according to the present invention will be described below in detail with reference to FIG. 6. FIG. 6 is a horizontal sectional view of a sheath portion 60 which constitutes a cable 30 and a shielding tubular member 50.

This fourth embodiment is characteristic in that, in manufacturing the shielding tubular member 50 which constitutes the cable 30, the diameter of the shielding tubular member 50 positioned near the mounted position of the ultrasonic probe head 20 is selected so as to be larger than the diameter of the shielding tubular member 50 spaced away from the mounted position of the ultrasonic probe head 20.

More specifically, as shown in FIG. 6, the diameter T₂ of the shielding tubular member 50 which constitutes the cable 30 at a position near the mounted position of the ultrasonic probe head 20 is selected so as to be larger than the diameter T₁ of the shielding tubular member 50 located at a position spaced away from the mounted position of the ultrasonic probe head 20 (T₂>T₁).

Also in this fourth embodiment, it is not that the diameter of the shielding tubular member is changed in relation to the length positions L and L′ of the cable 30, but that the diameter of the shielding tubular member is selected so as to gradually become larger stepwise or continuously toward the mounted position of the ultrasonic probe head 20, whereby the operability can be further improved.

According to this fourth embodiment, as described above, since the diameter of the shielding tubular member 50 positioned near the mounted position of the ultrasonic probe head 20 is selected so as to become larger than the diameter of the shielding tubular member 50 located at a position spaced away from the mounted position of the ultrasonic probe head 20, the portion of the cable 30 which is subjected to repeated bending in ultrasonic inspection can retain a certain degree of strength as in the prior art and the other portion, by being made to have a flexible structure with a reduced diameter of the shielding tubular member 50, can be improved in its operability in ultrasonic inspection while maintaining its structural reliability.

### Fifth Embodiment

Next, a fifth embodiment of the cable of the ultrasonic probe, as well as the ultrasonic probe, according to the present invention will be described below in detail with reference to FIG. 7. FIG. 7 is an enlarged horizontal sectional view of a shielding tubular member 50 which constitutes a cable 30.

This fifth embodiment is characteristic in that, in manufacturing the shielding tubular member 50 which constitutes the cable 30, the knitting density (size) of liner members 51 which constitute the shielding tubular member 50 is changed so as to become smaller as the mounted position of the ultrasonic probe head 20 is approached. The details of this fifth embodiment will be described below with reference to FIG. 7.

More specifically, in the shielding tubular member 50, as shown in FIG. 7, given that the knitting size of plural linear members 51 of the shielding tubular member 50 at the length position L is m and the knitting size (width) of plural linear members 51 of the shielding tubular member 50 at the length position L′ is m′, those knitting sizes are selected so as to satisfy the relationship of m<m′.

According to this fifth embodiment, as described above, the portion of the cable 30 which is subjected to repeated bending in ultrasonic inspection can retain a certain degree of strength as in the prior art and the other portion can be improved in its operability in ultrasonic inspection while maintaining its structural reliability.

### Sixth Embodiment

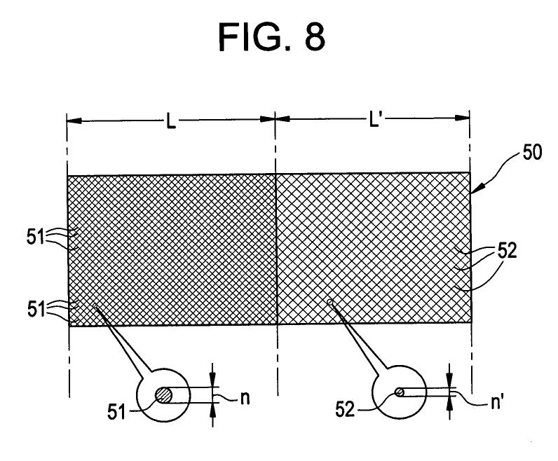

Next, a sixth embodiment of the cable of the ultrasonic probe, as well as the ultrasonic probe, according to the present invention will be described below in detail with reference to FIG. 8. FIG. 8 is an enlarged diagram of linear members 51 and 52 which constitute a shielding tubular member 50, based on arbitrary positions (length positions L and L′) of the shielding tubular member 50.

This sixth embodiment is characteristic in that, in manufacturing the shielding tubular member 50 which constitutes a cable 30, the diameter of each of the linear members 51 which constitute the shielding tubular member 50 near the mounted position of the probe head 10 is changed in accordance with the position of the cable 30 (the shielding tubular member 50).

More specifically, in the shielding tubular member 50, as shown in FIG. 8, given that the diameter of each of the linear members 51 which constitutes the shielding tubular member 50 at the length position L is n and the diameter of each of the linear members 52 which constitute the shielding tubular member 50 at the length position L is n and the diameter of each of the linear members 52 which constitute the shielding tubular member 50 at the length position L′ is n′, those diameters are selected so that n is larger than n′ (n>n′).

According to this sixth embodiment, as described above, at the mounted portion and thereabouts of the cable 30 where bending is repeated in ultrasonic inspection, a certain degree of strength can be maintained as in the prior art and the other portion, by being made to have a flexible structure with a reduced diameter of each of the linear members 51 which constitute the shielding tubular member 50, can be improved in its operability during ultrasonic inspection while maintaining its structural reliability.

Although the probe cable structure of the present invention has been described above as independent first to sixth embodiments, the characteristic portions of the first to sixth embodiments may be combined without regarding the embodiments as independent embodiments. For example, the construction of the first embodiment wherein the thickness of the sheath portion 60 is made variable and the construction of the fifth embodiment wherein the knitting size (width) of the linear members 51 which constitute the shielding tubular member 50 is made variable may be combined, or the construction of the third embodiment wherein the hardness of the sheath portion 60 is made variable and the construction of the sixth embodiment wherein the diameters of the linear members 51 and 52 which constitute the shielding tubular member 50 are made variable may be combined. By so doing, the operability in ultrasonic inspection using the ultrasonic probe can be further improved.

Many widely different embodiments of the invention may be configured without departing from the spirit and the scope of the present invention. It should be understood that the present invention is not limited to the specific embodiments described in the specification, except as defined in the appended claims.

1. A cable of an ultrasonic probe for connection between an ultrasonic probe head to be brought into abutment against a site to be inspected of a subject and a body of an ultrasonic diagnostic apparatus, wherein:
the thickness of a sheath portion which constitutes the cable on the side connected to the ultrasonic probe head is selected so as to be larger than the thickness of a sheath portion which constitutes the cable on the side connected to the body of the ultrasonic diagnostic apparatus.

2. A cable of an ultrasonic probe according to claim 1, wherein the thickness of the sheath portion which constitutes the cable on the side connected to the ultrasonic probe head is selected so as to become larger stepwise or continuously as the side connected to the ultrasonic probe head is approached.

3. A cable of an ultrasonic probe for connection between an ultrasonic probe head to be brought into abutment against a site to be inspected of a subject and a body of an ultrasonic diagnostic apparatus, wherein:
the hardness of a sheath portion which constitutes the cable on the side connected to the ultrasonic probe head is selected so as to be larger than the hardness of a sheath portion which constitutes the cable on the side connected to the body of the ultrasonic diagnostic apparatus.

4. A cable of an ultrasonic probe according to claim 3, wherein the hardness of the sheath portion which constitutes the cable on the side connected to the ultrasonic probe head is selected so as to become larger stepwise or continuously as the side connected to the ultrasonic probe head is approached.

5. A cable of an ultrasonic probe for connection between an ultrasonic probe head to be brought into abutment against a site to be inspected of a subject and a body of an ultrasonic diagnostic apparatus, wherein:
the cable comprises: a plurality of signal lines for transmitting electric signals to the ultrasonic probe head, the signal lines being disposed at a nearly central position of the cable; a shielding tubular member encloses the signal lines; and a sheath portion which encloses the shielding tubular member, and
the shielding tubular member is constituted by a plurality of linear members knitted like a net, and the diameter of the shielding tubular member on the side connected to the ultrasonic probe head is selected so as to be larger than the diameter of the shielding tubular member on the side connected to the body of the ultrasonic diagnostic apparatus.

6. A cable of an ultrasonic probe according to claim 5, wherein the diameter of the shielding tubular member on the side connected to the ultrasonic probe head is selected so as to become larger stepwise or continuously than the diameter of the shielding tubular member on the side connected to the body of the ultrasonic diagnostic apparatus.

7. A cable of an ultrasonic probe for connection between an ultrasonic probe head to be brought into abutment against a site to be inspected of a subject and a body of an ultrasonic diagnostic apparatus, wherein:
the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, and
the shielding tubular member being constituted by a plurality of tubular members knitted like a net, and the knitting density of the plural linear members is selected so that the knitting size becomes smaller as the side connected to the ultrasonic probe head is approached.

8. A cable of an ultrasonic probe according to claim 7, wherein the knitting density of the plural linear members is selected so that the knitting size becomes smaller stepwise or continuously as the side connected to the ultrasonic probe head is approached.

9. A cable of an ultrasonic probe for connection between an ultrasonic probe head to be brought into abutment against a site to be inspected of a subject and a body of an ultrasonic diagnostic apparatus, wherein:
the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, and
the shielding tubular member is constituted by a plurality of linear members knitted like a net, and the diameter of each of the linear members which constitute the shielding tubular member on the side connected to the ultrasonic probe head is selected so as to be larger than the diameter of each of the linear members which constitute the shielding tubular member on the side connected to the body of the ultrasonic diagnostic apparatus.

10. A cable of an ultrasonic cable according to claim 9, wherein the diameter of each of the linear members which constitute the shielding tubular member on the side connected to the ultrasonic probe head is selected so as to become larger stepwise or continuously than the diameter of each of the linear members which constitute the shielding tubular member on the side connected to the body of the ultrasonic diagnostic apparatus.

11. A cable of an ultrasonic probe according to claim 5, wherein the thickness of the sheath portion which constitutes the cable on the side connected to the ultrasonic probe head is selected so as to be larger than the thickness of the sheath portion which constitutes the cable on the side connected to the body of the ultrasonic diagnostic apparatus.

12. A cable of an ultrasonic probe according to claim 5, wherein the hardness of the sheath portion which constitutes the cable on the side connected to the ultrasonic probe head is selected so as to be larger than the hardness of the sheath portion which constitutes the cable on the side connected to the body of the ultrasonic diagnostic apparatus.

13. A cable of an ultrasonic probe according to claim 5, wherein the rigidity of the sheath portion which constitutes the cable on the side connected to the ultrasonic probe head is selected so as to be larger than the rigidity of the sheath portion which constitutes the cable on the side connected to the body of the ultrasonic diagnostic apparatus.

14. An ultrasonic probe comprising a cable for connection between an ultrasonic probe head to be brought into abutment against a site to be inspected of a subject and a body of an ultrasonic diagnostic apparatus, wherein:
the thickness of a sheath portion which constitutes the cable on the side connected to the ultrasonic probe head is selected so as to be larger than the thickness of a sheath portion which constitutes the cable on the side connected to the body of the ultrasonic diagnostic apparatus.

15. An ultrasonic probe comprising a cable for connection between an ultrasonic probe head to be brought into abutment against a site to be inspected of a subject and a body of an ultrasonic diagnostic apparatus, wherein:
the hardness of a sheath portion which constitutes the cable on the side connected to the ultrasonic probe head is selected so as to be larger than the hardness of a sheath portion which constitutes the cable on the side connected to the body of the ultrasonic diagnostic apparatus.

16. An ultrasonic probe comprising a cable for connection between an ultrasonic probe head to be brought into abutment against a site to be inspected of a subject and a body of an ultrasonic diagnostic apparatus, wherein:
the cable comprises: a plurality of signal lines for transmitting electric signals to the ultrasonic probe head, the signal lines being disposed at a nearly central position of the cable; a shielding tubular member which encloses the signal lines; and a sheath portion which encloses the shielding tubular member, and
the shielding tubular member is constituted by a plurality of linear members knitted like a net, and the diameter of the shielding tubular member on the side connected to the ultrasonic probe head is selected so as to be larger than the diameter of the shielding tubular member on the side connected to the body of the ultrasonic diagnostic apparatus.

17. An ultrasonic probe comprising a cable for connection between an ultrasonic probe head to be brought into abutment against a site to be inspected of a subject and a body of an ultrasonic diagnostic apparatus, wherein:
the cable comprises: a plurality signal lines for transmitting electric signals to the ultrasonic probe head, the signal lines being disposed at a nearly central position of the cable; a shielding tubular member which encloses the signal lines; and a sheath portion which encloses the shielding tubular member, and
the shielding tubular member is constituted by a plurality of linear members knitted like a net, and the knitting density of the plural linear members is selected so that the knitting size becomes smaller as the side connected to the ultrasonic probe head is approached.

18. A cable of an ultrasonic probe according to claim 7, wherein the thickness of the sheath portion which constitutes the cable on the side connected to the ultrasonic probe head is selected so as to be larger than the thickness of the sheath portion which constitutes the cable on the side connected to the body of the ultrasonic diagnostic apparatus.

19. A cable of an ultrasonic probe according to claim 7, wherein the hardness of the sheath portion which constitutes the cable on the side connected to the ultrasonic probe head is selected so as to be larger than the hardness of the sheath portion which constitutes the cable on the side connected to the body of the ultrasonic diagnostic apparatus.

20. A cable of an ultrasonic probe according to claim 7, wherein the rigidity of the sheath portion which constitutes the cable on the side connected to the ultrasonic probe head is selected so as to be larger than the rigidity of the sheath portion which constitutes the cable on the side connected to the body of the ultrasonic diagnostic apparatus.

21. A cable of an ultrasonic probe according to claim 9, wherein the thickness of the sheath portion which constitutes the cable on the side connected to the ultrasonic probe head is selected so as to be larger than the thickness of the sheath portion which constitutes the cable on the side connected to the body of the ultrasonic diagnostic apparatus.

22. A cable of an ultrasonic probe according to claim 9, wherein the hardness of the sheath portion which constitutes the cable on the side connected to the ultrasonic probe head is selected so as to be larger than the hardness of the sheath portion which constitutes the cable on the side connected to the body of the ultrasonic diagnostic apparatus.

23. A cable of an ultrasonic probe according to claim 9, wherein the rigidity of the sheath portion which constitutes the cable on the side connected to the ultrasonic probe head is selected so as to be larger than the rigidity of the sheath portion which constitutes the cable on the side connected to the body of the ultrasonic diagnostic apparatus.
